(19) United States
(12) Patent Application Publication
(10) Pub. No.: US 2015/0300217 A1
(43) Pub. Date: Oct. 22, 2015

(54) INTERNAL COMBUSTION ENGINE AND CONTROL METHOD FOR INTERNAL COMBUSTION ENGINE

(71) Applicant: Eiichi HIOKA, Toyota-shi (JP)

(72) Inventor: Eiichi HIOKA, Toyota-shi (JP)

(73) Assignee: TOYOTA JIDOSHA KABUSHIKI KAISHA, Toyota-shi, Aichi-ken (JP)

(21) Appl. No.: 14/435,359

(22) PCT Filed: Jan. 29, 2014
(86) PCT No.: PCT/IB2014/000188

§ 371 Date: Apr. 13, 2015

(30) Foreign Application Priority Data
Jan. 31, 2013 (JP) 2013-016701

(51) Int. Cl. F01L 13/00; F02B 37/18; F02D 13/02; F02M 25/07

(52) U.S. Cl. CPC F01L 13/0063; F02M 25/0706; F02B 37/18; F02D 13/023

(57) ABSTRACT

An internal combustion engine includes a variable valve mechanism that takes a valve characteristic of an intake valve, and changes the valve characteristic according to an engine operating state; a turbocharger that includes a bypass passage that bypasses a turbine wheel arranged in an exhaust passage by connecting a portion of the exhaust passage that is upstream of the turbine wheel to a portion of the exhaust passage that is downstream of the turbine wheel, and a waste gate valve that adjusts a flow path area of the bypass passage; and a control apparatus configured to, when there is a request to increase the valve characteristic according to a change in the engine operating state, change the valve characteristic to an increase side with the variable valve mechanism after opening the waste gate valve to an opening amount that is larger than before the request.

### BACKGROUND OF THE INVENTION

1. Field of the Invention

The invention relates to an internal combustion engine provided with a variable valve mechanism, and a control method for controlling the internal combustion engine.

2. Description of Related Art

A variable valve mechanism that changes a valve characteristic (valve opening characteristic) of an intake valve according to an operating state of an internal combustion engine is known. For example, Japanese Patent Application Publication No. 2004-339951 (JP 2004-339951 A) describes a multi-stage variable valve mechanism that takes at least one of an operation angle and a maximum lift amount of an intake valve as a valve characteristic, and changes this valve characteristic in stages.

In addition to the multi-stage variable valve mechanism described above, there is also a continuously variable valve mechanism that continuously (smoothly without stages) changes the valve characteristic of an intake valve.

### SUMMARY OF THE INVENTION

However, with the multi-stage variable valve mechanism described above, a plurality of valve characteristics that differ greatly in magnitude from each other are set. Therefore, a valve characteristic of the intake valve may abruptly change greatly to the increase side. In this case, with the change in this valve characteristic of the intake valve, an amount of air drawn into the internal combustion engine may abruptly increase, possibly causing output torque of the internal combustion engine to increase all at once.

This problem is not limited to the multi-stage variable valve mechanism described above, and may also similarly occur when the valve characteristic abruptly changes greatly to the increase side in an internal combustion engine provided with a continuously variable valve mechanism as well.

The invention thus provides an internal combustion engine, and a control method for an internal combustion engine, capable of inhibiting output torque of the internal combustion engine from abruptly increasing following a change to an increase side in a valve characteristic of an intake valve.

A first aspect of the invention relates to an internal combustion engine that includes a variable valve mechanism that takes at least one of an operation angle and a maximum lift amount of an intake valve as a valve characteristic, and changes the valve characteristic according to an engine operating state; a turbocharger that includes a bypass passage that bypasses a turbine wheel arranged in an exhaust passage by connecting a portion of the exhaust passage that is upstream of the turbine wheel to a portion of the exhaust passage that is downstream of the turbine wheel, and a waste gate valve that adjusts a flow path area of the bypass passage; and a control apparatus configured to, when there is a request to increase the valve characteristic according to a change in the engine operating state, change the valve characteristic to an increase side with the variable valve mechanism after opening the waste gate valve to an opening amount that is larger than before the request.

According to this aspect, in the internal combustion engine, the valve characteristic of the intake valve is variably controlled according to the engine operating state by the variable valve mechanism. Also, in the turbocharger, exhaust discharged from the internal combustion engine to the exhaust passage is blown at the turbine wheel, thus rotatably driving the turbine wheel. Consequently, a compressor wheel that is on the same shaft as the turbine wheel rotates together with the turbine wheel, such that supercharging is performed. That is, the air that is drawn in is compressed and forced into the internal combustion engine. Moreover, when the waste gate valve opens, at least some of the exhaust bypasses the turbine wheel and is discharged via the bypass passage according to the opening amount of the waste gate valve.

Here, if there is a request to change the valve characteristic of the intake valve to the increase side according to a change in the engine operating state, the waste gate valve will open to an opening amount that is larger than before the request. The amount of exhaust that bypasses the turbine wheel and is discharged via the bypass passage becomes larger than before the request. Compared to before the request, the exhaust pressure decreases by the amount of exhaust that flows through the bypass passage, so the rotation speed of the turbine wheel will decrease. Consequently, the force with which air is fed in by the compressor wheel weakens, so the boost pressure decreases.

Also, after operating the waste gate valve to the open side, the valve characteristic of the intake valve is changed to the increase side by the variable valve mechanism. Therefore, if the valve characteristic of the intake valve changes abruptly to the increase side, the amount of air drawn into the internal combustion engine will abruptly increase, but this increase will be under a situation in which the boost pressure is decreased as described above, so an abrupt increase in the output torque of the internal combustion engine is able to be suppressed.

In the internal combustion engine described above, the waste gate valve may be opened to an opening amount according to a requested amount of change in the valve characteristic. Here, if the valve characteristic of the intake valve is abruptly changed to the increase side by the variable valve mechanism, the amount of air drawn into the internal combustion engine will increase by an amount according to the amount of change in the valve characteristic. On the other hand, if the waste gate valve is open, the exhaust pressure and the boost pressure will decrease by an amount according to the amount of change in the opening amount of the valve to the open side.

Regarding this, with the structure described above, the waste gate valve is open an opening amount according to the requested amount of change in the valve characteristic. Therefore, as opposed to when the waste gate valve is always open a constant amount, an abrupt increase in the output torque of the internal combustion engine caused by a sudden increase in the intake air amount is able to be appropriately suppressed, regardless of the amount of change in the valve characteristic, so the output torque approaches the target value.

In the structure described above, the waste gate valve may be opened to a larger amount when the requested amount of change in the valve characteristic is large than when the requested amount of change in the valve characteristic is small. Here, the amount of air drawn into the internal combustion engine is small when the amount of change in the valve characteristic to the increase side is small, and increases as this amount of change increases. On the other hand, the amount of decrease in the exhaust pressure and the boost pressure decreases when the amount of change in the opening amount of the waste gate valve to the open side is small, and increases as this amount of change increases.

Regarding this, according to this structure, the waste gate valve is open a larger amount when the requested amount of change in the valve characteristic is large as opposed to small. Therefore, an abrupt increase in the output torque of the internal combustion engine caused by a sudden increase in the intake air amount is able to be appropriately suppressed, regardless of the requested amount of change in the valve characteristic, so the output torque will approach the target value.

In the aspect described above, the variable valve mechanism may be a multi-stage variable valve mechanism that changes the valve characteristic in multiple stages by selecting one from among a plurality of predetermined valve characteristics.

Here, in the multi-stage variable valve mechanism, a plurality of valve characteristics that differ greatly in magnitude from each other are set. Therefore, the amount of change when the valve characteristic changes tends to be more than it is with a continuously variable valve mechanism that continuously (i.e., smoothly) changes the valve characteristic of the intake valve. With the multi-stage variable valve mechanism, the valve characteristic of the intake valve is more easily abruptly changed greatly to the increase side than it is with a continuously variable valve mechanism.

Accordingly, with the structure described above, in an internal combustion engine provided with a multi-stage variable valve mechanism, an effect in which an abrupt increase in the output torque of the internal combustion engine is suppressed is able to be effectively obtained by performing the control of the waste gate valve and the variable valve mechanism described above.

In the structure described above, three or more of stages of the valve characteristics may be set, and the request may include a request to change the valve characteristics from a valve characteristic before the request to a valve characteristic two stages larger, from among the plurality of valve characteristics.

In an internal combustion engine provided with a multi-stage variable valve mechanism in which three or more valve characteristics are set, more air is drawn into the engine when the valve characteristic is changed to a valve characteristic that is two stages larger, than when the valve characteristic is changed to a valve characteristic that is one stage larger. A phenomenon in which the output torque of the internal combustion engine abruptly increases following a change in the valve characteristic of the intake valve tends to occur more easily.

Therefore, with the structure described above, when there is a request that includes a request to change the valve characteristic from a valve characteristic before the request to a valve characteristic that is two stages larger, from among the plurality of valve characteristics, an effect in which an abrupt increase in the output torque of the internal combustion engine is suppressed is able to be effectively obtained by performing the control of the waste gate valve and the variable valve mechanism described above.

In the structure described above, the request may include a request to change the valve characteristics from a smallest valve characteristic to a largest valve characteristic, from among the plurality of valve characteristics. One situation in which there is a request to change from the valve characteristic before the request to a valve characteristic that is two stages larger, from among the plurality of valve characteristics, is when there is a request to change from the smallest valve characteristic to the largest valve characteristic, when there are three or more valve characteristics, as in the structure described above, for example. In this case, the valve characteristic will be changed the largest of any possible change. A phenomenon in which a large amount of air is abruptly drawn into the internal combustion engine, such that the output torque of the internal combustion engine increases abruptly, following a change in the valve characteristic of the intake valve also tends to occur more easily.

Accordingly, with the structure described above, when there is a request that includes a request to change the valve characteristic from the smallest valve characteristic to the largest valve characteristic, from among a plurality of valve characteristics, an effect in which an abrupt increase in the output torque of the internal combustion engine is suppressed is able to be effectively obtained by performing the control of the waste gate valve and the variable valve mechanism described above.

Also, a second aspect of the invention relates to a control method for an internal combustion engine including a variable valve mechanism that takes at least one of an operation angle and a maximum lift amount of an intake valve as a valve characteristic, and changes the valve characteristic according to an engine operating state; and a turbocharger that includes a bypass passage that bypasses a turbine wheel arranged in an exhaust passage by connecting a portion of the exhaust passage that is, upstream of the turbine wheel to a portion of the exhaust passage that is downstream of the turbine wheel, and a waste gate valve that adjusts a flow path area of the bypass passage. This control method includes, when there is a request to increase the valve characteristic according to a change in the engine operating state, changing the valve characteristic to an increase side with the variable valve mechanism after opening the waste gate valve to an opening amount that is larger than before the request.

According to this aspect, an effect similar to that obtained by the first aspect described above can be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing a frame format of the general structure of an internal combustion engine and a turbocharger according to one example embodiment of the internal combustion engine of the invention;

FIG. 2 is a sectional view of the structure around a cylinder head of the internal combustion engine according to the example embodiment;

FIG. 3 is a perspective view of a variable mechanism portion of a variable valve mechanism according to the example embodiment, with a portion thereof cut away;

FIG. 4 is a view showing a frame format of the variable valve mechanism according to the example embodiment;

FIG. 5 is an explanatory view of a profile of a cam provided in the variable valve mechanism according to the example embodiment;

FIG. 6 is a characteristic diagram showing the relationship between rotation angle of the cam (motor) and a maximum lift amount of an intake valve that is changed by the variable valve mechanism, according to the example embodiment;

FIG. 7 is a flowchart illustrating a process flow of control performed on the variable valve mechanism and a waste gate valve when there is a request for an increase in the maximum lift amount according to the example embodiment;

FIG. 8A is a timing chart illustrating the manner of change in the maximum lift amount;

FIG. 8B is a timing chart illustrating the manner of change in an opening amount of the waste gate valve; and

FIG. 8C is a timing chart illustrating the manner of change in a boost pressure (output torque of the internal combustion engine).

### DETAILED DESCRIPTION OF EMBODIMENTS

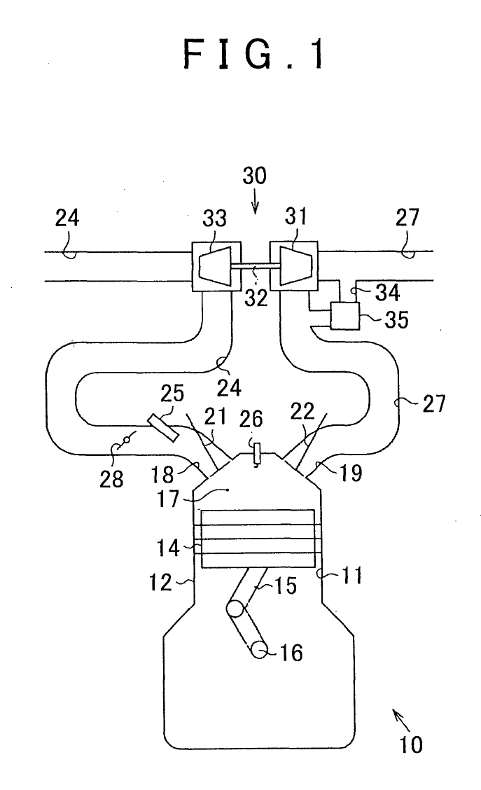

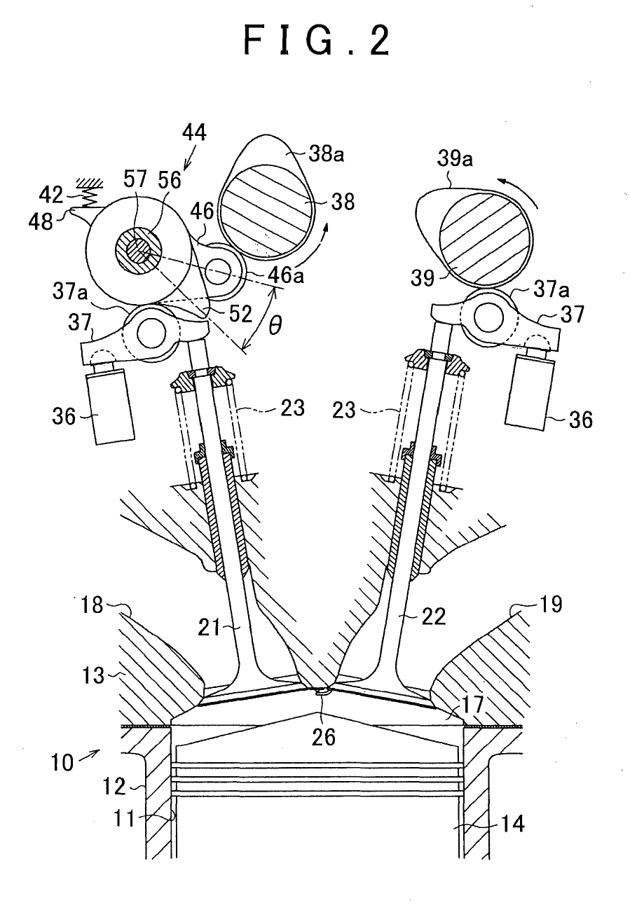

Hereinafter, an example embodiment of an internal combustion engine will be described with reference to the accompanying drawings. First, the general structure of the internal combustion engine will be described. As shown in FIGS. 1 and 2, an internal combustion engine 10 includes a cylinder block 12 having a plurality of cylinders 11, and a cylinder head 13 arranged on an upper side of the cylinder block 12. A piston 14 is housed, so as to be able to move in a reciprocating manner, in each cylinder 11. Each piston 14 is connected to a crankshaft 16 that is an output shaft of the internal combustion engine 10, via a connecting rod 15. The reciprocating motion of each piston 14 is converted into rotary motion by the connecting rod 15, and then transmitted to the crankshaft 16.

A space surrounded by the piston 14, the cylinder 11, and the cylinder head 13 forms a combustion chamber 1.7 of each cylinder 11. A pair of intake ports 18 and a pair of exhaust ports 19 that are communicated with each combustion chamber 17 are provided in the cylinder head 13.

In order to open and close the intake ports 18, a pair of intake valves 21 are supported, so as to be able to move in a reciprocating manner, for each cylinder 11, in the cylinder head 13. Also, in order to open and close the exhaust ports 19, a pair of exhaust valves 22 are supported, so as to be able to move in a reciprocating manner, for each cylinder 11, in the cylinder head 13. The intake valves 21 and the exhaust valves 22 are each urged generally upward by a valve spring 23. This urging direction is a direction that closes the intake ports 18 and the exhaust ports 19 (i.e., a valve-closing direction).

A valve mechanism that opens each intake port 18 (i.e., places each intake port 18 in a valve-open state) by pushing the intake valves 21 down against the valve springs 23 is provided in the cylinder head 13. Also, a valve mechanism that opens each exhaust port 19 (i.e., places each exhaust port 19 in a valve-open state) by pushing the exhaust valves 22 down against the valve springs 23 is provided in the cylinder head 13. These valve mechanisms will be described later.

An intake passage 24 is connected to all of the intake ports 18, and air from outside the internal combustion engine 10 is drawn into the combustion chamber 17 of each cylinder 11 through the intake passage 24 and the intake ports 18. A fuel injection valve 25 for injecting fuel is mounted for each cylinder 11, in the intake passage 24. Fuel injected from each fuel injection valve 25 mixes with intake air introduced into the combustion chamber 17 through the corresponding intake ports 18 to become an air-fuel mixture. Fuel may also be injected directly into the combustion chambers 17 from the fuel injection valves 25 by mounting the fuel injection valves 25 in the cylinder head 13 instead of in the intake passage 24.

A spark plug 26 for each cylinder 11 is mounted in the cylinder head 13. The air-fuel mixture in each combustion chamber 17 is ignited by an electric spark from the spark plug 26, and combusted. The pistons 14 are driven in a reciprocating manner by high-temperature high-pressure combustion gases produced with this combustion, and as a result, the crankshaft 16 is rotated and driving force (output torque) of the internal combustion engine 10 is obtained.

Meanwhile, an exhaust passage 27 is connected to all of the exhaust ports 19. The combustion gas produced in the combustion chambers 17 is discharged as exhaust out of the internal combustion engine 10 through the exhaust ports 19 and the exhaust passage 27 and the like.

Part of an output adjustment of the internal combustion engine 10 is realized by adjusting an opening amount (throttle opening amount) of a throttle valve 28 provided in the intake passage 24. That is, when the throttle opening amount is adjusted, the amount of air drawn into the internal combustion engine 10 (i.e., the intake air amount) changes. The fuel injection quantity from the fuel injection valves 25 is controlled in response to this change such that the amount of air-fuel mixture charged into each combustion chamber 17 changes, and consequently, the output of the internal combustion engine 10 is adjusted.

In order to increase the charging efficiency of air by effectively using the high pressure of the exhaust (i.e., the exhaust pressure), the internal combustion engine 10 is provided with a turbocharger 30 that serves as a supercharger. The turbocharger 30 includes a turbine wheel 31 that rotates by the exhaust flowing through the exhaust passage 27 and the pressure of this exhaust (i.e., the exhaust pressure), and a compressor wheel 33 that is arranged upstream of the throttle valve 28 in the intake passage 24, and is connected to the turbine wheel 31 by a rotor shaft 32. In the turbocharger 30, exhaust is blown at the turbine wheel 31, which causes the turbine wheel 31 to rotate, and this rotation is transmitted to the compressor wheel 33 via the'rotor shaft 32. As a result, not only is air sent into the combustion chamber 17 by the negative pressure created inside the combustion chamber 17 as the piston 14 moves, but this air is compressed by the rotation of the compressor wheel 33 and forcibly sent into the combustion chamber 17 (supercharged). In this way, the charging efficiency of air into the combustion chamber 17 is increased.

The turbocharger 30 is provided with a bypass passage 34 that bypasses the turbine wheel 31 by connecting a portion of the exhaust passage 27 upstream of the turbine wheel 31 to a portion of the exhaust passage 27 downstream of the turbine wheel 31. A waste gate valve (hereinafter, simply referred to as “WGV”) 35 is provided in the bypass passage 34. This WGV 35 adjusts the flow path area of the bypass passage 34 by driving a valve body arranged in the bypass passage 34 open and closed using an actuator. The actuator may be one that drives the valve body by an electric motor, or one that drives the valve body by negative pressure, or the like.

The bypass passage 34 and the WGV 35 are generally provided to keep the boost pressure from exceeding a predetermined value (i.e., to inhibit excessive boost pressure from being generated). In this example embodiment, in addition to this, the bypass passage 34 and the WGV 35 are also provided to inhibit the output torque of the internal combustion engine 10 from abruptly increasing following a change to the increase side in a valve characteristic of the intake valves 21 (hereinafter, the intake valves 21 and other components that are provided in plurality may be referred to in the singular to simplify the description). The valve characteristic of the intake valve 21 is at least one of a maximum lift amount and an operation angle, and in this example embodiment, both of these are valve characteristics. However, hereinafter, for the sake of simplicity, the maximum lift amount will be described as the valve characteristic. The maximum lift amount is a displacement amount (lift amount) when the intake valve 21 is displaced as much as can be in the valve-opening direction. Also, the operation angle is an angular range (i.e., a valve-open period) from when the intake valve 21 starts to open until the intake valve 21 closes.

When the WGV 35 closes, the flow path area of the bypass passage 34 becomes “0”, and exhaust does not flow through the bypass passage 34. In contrast, when the WGV 35 is open even slightly, the flow path area of the bypass passage 34 is greater than “0”, and at least some of the exhaust is discharged via the bypass passage 34 while bypassing the turbine wheel 31. The flow path area of the bypass passage 34 increases as the opening amount of the WGV 35 increases. When exhaust flows through the bypass passage 34, the exhaust pressure upstream of the turbine wheel 31 consequently decreases, and the driving of the turbocharger 30 is inhibited (i.e., the rotation speed of the turbine wheel 31 decreases). As a result, the amount of air that is forced in by the compressor wheel 33 decreases, so the boost pressure decreases.

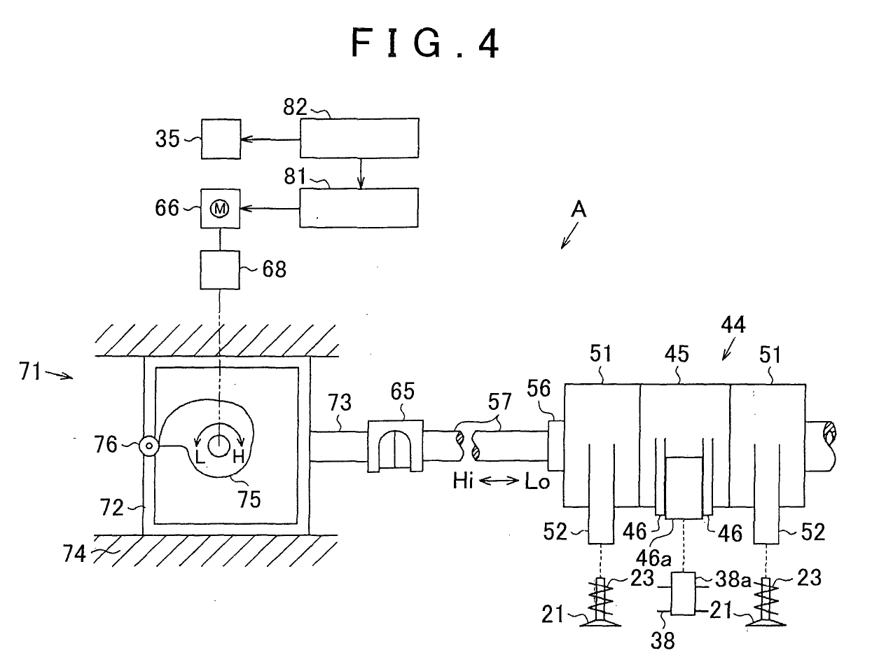

The WGV 35 is connected to an engine control unit 82 (see FIG. 4) that controls the operating state of the internal combustion engine 10. Operation of the WGV 35 is controlled by this engine control unit 82. For example, when there is no request to greatly increase the maximum lift amount of the intake valve 21, a target opening amount of the WGV 35 is calculated based on the engine operating state such as the engine speed and engine load and the like. The WGV 35 is controlled (i.e., driven) so that the actual opening amount comes to match the target opening amount. Output torque required from the internal combustion engine 10 by a driver is realized by controlling the opening amount of this WGV 35, and controlling the opening amount of the throttle valve 28 described above.

Also, when there is a request to greatly increase the maximum lift amount, a target opening amount of the WGV 35 is increased and the actuator of the WGV 35 is controlled (i.e., driven) so that the actual opening amount comes to match this target opening amount, before the maximum lift amount is changed. At the time of this control, the target opening amount of the WGV 35 is selected and set from among three amounts, i.e., “0”, “Small”, and “Large”.

Next, the valve mechanisms of the intake valves 21 and the exhaust valves 22 will be described with reference to FIG. 2. A lash adjuster 36 is provided for each intake valve 21 and each exhaust valve 22. A rocker arm 37 is provided both between the lash adjuster 36 and the intake valve 21, and between the lash adjuster 36 and the exhaust valve 22. The rocker arm 37 is supported at one end by the lash adjuster 36, while the other end abuts against an upper end portion of the intake valve 21 or an upper end portion of the exhaust valve 22.

An intake cam shaft 38 that has an intake cam 38a is rotatably supported above the intake valve 21 in the cylinder head 13 (see FIG. 4). Similarly, an exhaust cam shaft 39 that has an exhaust cam 39a is rotatably supported above the exhaust valve 22 in the cylinder head 13. The intake cam shaft 38 and the exhaust cam shaft 39 are drivingly connected to the crankshaft 16 (see FIG. 1) by a timing chain, not shown, and the like. Also, the rotation of the crankshaft 16 is transmitted to the intake cam shaft 38 and the exhaust cam shaft 39 via the timing chain and the like.

An outer peripheral surface of the exhaust cam 39a abuts against a roller 37a of the rocker arm 37 that abuts against the exhaust valve 22. Therefore, when the exhaust cam shaft 39 rotates while the engine is operating, the action of the exhaust cam 39a causes the rocker arm 37 to rock with the portion supported by the lash adjuster 36 as the fulcrum, such that the exhaust valve 22 is pushed down against the valve spring 23. When the exhaust valve 22 is pushed down in this way, the exhaust port 19 is open (i.e., in a valve-open state). The lash adjuster 36, the rocker arm 37, and the exhaust cam shaft 39 and the like together form the mechanism (valve mechanism) that drives the exhaust valve 22 open and closed.

Meanwhile, the mechanism (driving mechanism) that drives the intake valve 21 open and closed is formed by a variable valve mechanism A that varies the maximum lift amount of the intake valve 21. A portion of the variable valve mechanism A is formed by a variable mechanism portion 44 of each cylinder 11, which is arranged between the intake cam 38a and the rocker arm 37 that abuts against the intake valve 21. This variable mechanism portion 44 has an input arm 46 and an output arm 52. The input arm 46 and the output arm 52 are rockably supported about a support pipe 56 that is fixed to the cylinder head 13. The rocker arm 37 is urged toward the output arm 52 side by the urging force of the valve spring 23, such that the roller 37a provided on a middle portion of the rocker arm 37 abuts against an outer peripheral surface of the output arm 52.

Also, a protrusion 48 is provided on an outer peripheral surface of the variable mechanism portion 44. Urging force of a spring 42 attached inside the cylinder head 13 acts on this protrusion 48. This urging force causes a roller 46a provided on a tip end of the input arm 46 to abut against an outer peripheral surface of the intake cam 38a. Therefore, when the intake cam shaft 38 rotates while the engine is operating, the action of the intake cam 38a causes the variable mechanism portion 44 to rock about the support pipe 56. Also, the rocker arm 37 is pushed by the output arm 52 via the roller 37a, which causes the rocker arm 37 to rock with a portion supported by the lash adjuster 36 as the fulcrum, such that the intake valve 21 is pushed down against the valve spring 23. When the intake valve 21 is pushed down in this way, the intake port 18 is open (i.e., in a valve-open state).

A control shaft 57 is inserted, so as to be able to move in an axial direction thereof, in the support pipe 56. The variable mechanism portion 44 changes a relative phase difference, i.e., an angle θ shown in FIG. 2, between the output arm 52 and the input arm 46 with the support pipe 56 as the center, by displacing the control shaft 57 in the,axial direction.

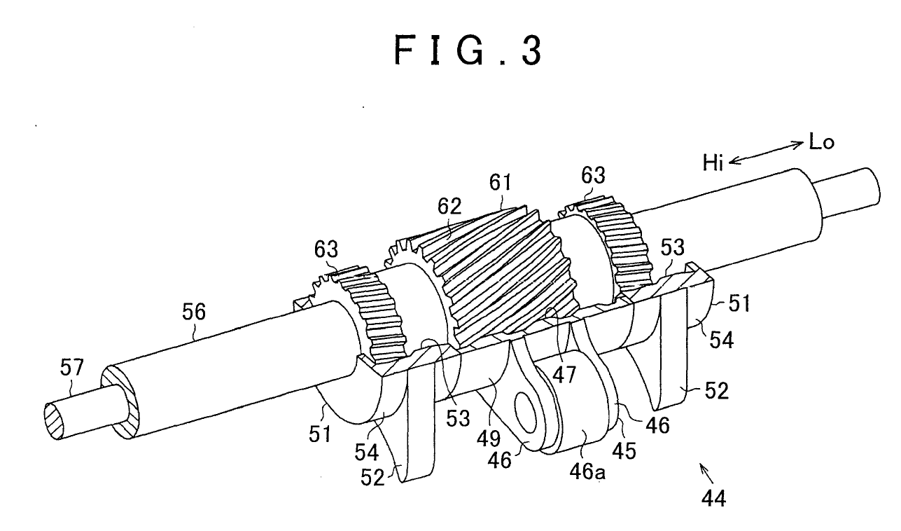

Next, the structure of the variable mechanism portion 44 will be described in further detail with reference to FIG. 3. An input portion 45, and a pair of output portions 51 that sandwich this input portion 45 from both sides in the axial direction, are arranged on the variable mechanism portion 44. A housing 49 of the input portion 45 and a housing 54 of each output portion 51 are both formed in hollow cylindrical shapes. The support pipe 56 is inserted through the insides of these housings 49 and 54.

A helical spline 47 is formed on an inner periphery of the housing 49 of the input portion 45. Meanwhile, a helical spline 53 having a tooth trace in the reverse direction as the tooth trace of the helical spline 47 of the input portion 45 is formed on an inner periphery of the housing 54 of each output portion 51.

A slider gear 61 is arranged in a series of internal spaces formed by the housing 49 of the input portion 45 and the housing 54 of both output portions 51. The slider gear 61 is formed in a hollow cylindrical shape, and is arranged on an outer peripheral surface of the support pipe 56 in a manner so as to both be able to move in a reciprocating fashion in the axial direction of the support pipe 56, and rotate relatively around its axis.

A helical spline 62 that is in mesh with the helical spline 47 of the input portion 45 is formed on an outer peripheral surface of the center portion of the slider gear 61 in the axial direction. Meanwhile, helical splines 63 that are in mesh with the helical splines 53 of the output portions 51 are formed on outer peripheral surfaces of both side portions of the slider gear 61 in the axial direction.

The control shaft 57 and the slider gear 61 are drive-connected (engaged) by a pin, not shown. This drive connection (engagement) enables the slider gear 61 to rotate with respect to the support pipe 56. Also, the slider gear 61 also moves in the axial direction with the movement of the control shaft 57 in the axial direction.

With the variable mechanism portion 44 structured in this way, when the control shaft 57 moves in the axial direction, the slider gear 61 also moves in the axial direction in conjunction with this movement. The helical splines 62 and 63 formed on the outer peripheral surface of the slider gear 61 have tooth traces that are formed in different directions, and are in mesh with the helical splines 47 and 53, respectively, formed on the inner peripheral surfaces of the input portion 45 and the output portions 51. Therefore, when the slider gear 61 moves in the axial direction, the input portion 45 and the output portions 51 rotate in opposite directions from each other. As a result, the relative phase difference (angle θ in FIG. 2) between the input arm 46 and both output arms 52 changes, so the maximum lift amount of the intake valve 21 changes.

In this example embodiment, when the control shaft 57 is moved in the direction indicated by arrow Hi in FIG. 3, the slider gear 61 moves together with the control shaft 57 in the same direction. The relative phase difference (i.e., the angle θ in FIG. 2) between the input arm 46 and the output arm 52 increases, so the maximum lift amount VL and the operation angle (valve-open period) of the intake valve 21 also increase, and as a result, the intake air amount increases. On the other hand, when the control shaft 57 is moved in the direction indicated by the arrow Lo in FIG. 3, the slider gear 61 moves together with the control shaft 57 in the same direction The relative phase difference (i.e., the angle θ in FIG. 2) between the input arm 46 and the output arm 52 decreases, so the maximum lift amount VL and the operation angle (valve-open period) of the intake valve 21 also decrease, and as a result, the intake air amount decreases.

Next, the structure of a driving portion that moves the control shaft 57 of the variable valve mechanism A in the axial direction will be described. As shown in'FIG. 4, the driving portion of the variable valve mechanism A includes an electric motor 66, a reduction mechanism 68 that decelerates the rotation of the motor 66, and a conversion mechanism 71 that converts the rotary motion of the reduction mechanism 68 into linear motion of the control shaft 57.

The reduction mechanism 68 is provided with a plurality of gears and the like. An input shaft of the reduction mechanism 68 is connected to an output shaft of the motor 66, and an output shaft of the reduction mechanism 68 is connected to a cam 75 provided in the conversion mechanism 71.

The conversion mechanism 71 includes a holder 72, and a guide 74 that guides the movement of this holder 72. A connecting shaft 73 that extends toward the control shaft 57 is attached to the holder 72. An end portion of the connecting shaft 73 is connected to an end portion on the connecting shaft 73 side of the control shaft 57 by a connecting member 65.

The cam 75 that is rotated by the output shaft of the reduction mechanism 68 is arranged inside the holder 72. Also, a roller 76 that contacts a cam surface of the cam 75 is rotatably attached to the holder 72.

When the cam 75 rotates, the holder 72 as a driven section that is a member to which the movement of the cam 75 is transmitted, moves along the guide 74. This movement of the holder 72 displaces the control shaft 57 in the axial direction.

A motor control unit 81 is connected to the motor 66. The rotation angle of the motor 66 is controlled in response to a drive signal from the motor control unit 81. The motor control unit 81 is connected to an engine control unit 82 that controls the operating state of the internal combustion engine 10.

The engine control unit 82 receives signals indicative of an accelerator operation amount detected by an accelerator operation amount sensor, and a crank angle detected by a crank angle sensor and the like. Then the engine control unit 82 calculates a required intake air amount according to the engine operating state based on the accelerator operation amount and the engine speed calculated from the crank angle, and the like, and calculates the maximum lift amount of the intake valve 21 at which the required intake air amount can be obtained, for example. Then the engine control unit 82 sets the calculated maximum lift amount as target lift amount. When the target lift amount is set in this way, the motor control unit 81 calculates a rotation phase of the cam 75 corresponding to the target lift amount, and controls the rotation angle of the motor 66 to achieve this calculated rotation phase.

The driving of the motor 66 is duty-controlled by the motor control unit 81. The duty ratio applied to the motor 66 when operating the motor 66, i.e., when changing the maximum lift amount, is set to a value close to approximately a maximum value. Therefore, the output torque of the motor 66 becomes a value close to the maximum value, so the control shaft 57 moves at a speed close to maximum speed.

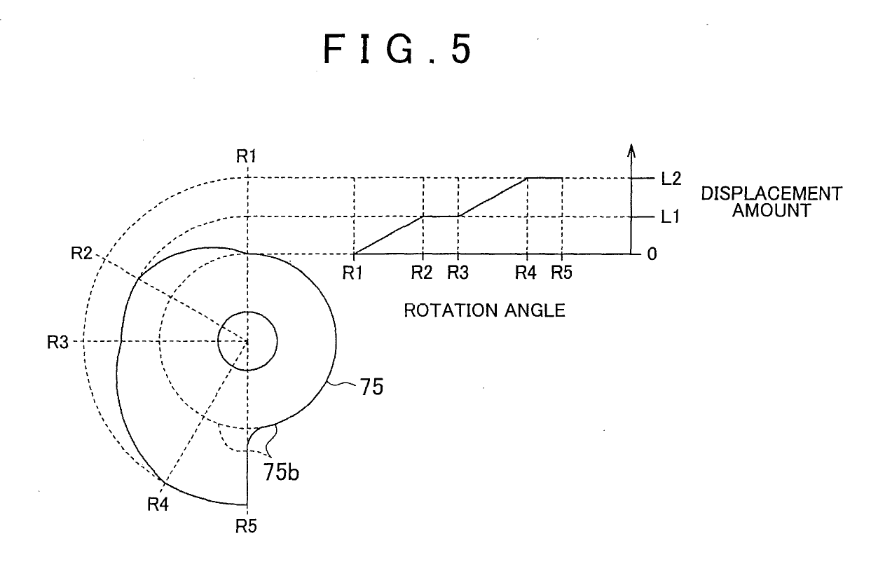

Next, the cam 75 that displaces the control shaft 57 will be described in detail. As shown in FIG. 5, zones where the displacement amount of the control shaft 57 increases linearly (i.e., a zone from a first rotation angle R1 to a second rotation angle R2, and a zone from a third rotation angle R3 to a fourth rotation angle R4) due to a cam radius (a radius from the rotational center to the cam surface) gradually increasing in one direction, are set on the cam surface of the cam 75. Also, zones where the displacement amount of the control shaft 57 is constant (i.e., a zone from the second rotation angle R2 to the third rotation angle R3, a zone from the fourth rotation angle R4 to a fifth rotation angle R5, and a zone before the first rotation angle R1 where the roller 76 contacts a reference circle 75b of the cam 75) due to the cam radius being constant, are also set on the cam surface of the cam 75.

More specifically, in the zone where the rotation angle of the 75 is before the first rotation angle R1, the displacement amount of the control shaft 57 is maintained at “0”. Also, in the zone where the rotation angle of the cam 75 is between the second rotation angle R2 and the third rotation angle R3, the displacement amount of the control shaft 57 is maintained at “L1” that is a constant value. Also, in the zone where the rotation angle of the cam 75 is between the fourth rotation angle R4 and the fifth rotation angle R5, the displacement amount of the control shaft 57 is maintained at “L2” that is a constant value that is larger than “L1”. In this way, the zones where the displacement amount of the control shaft 57 is constant (L1 and L2) will hereinafter be referred to as “holding regions”.

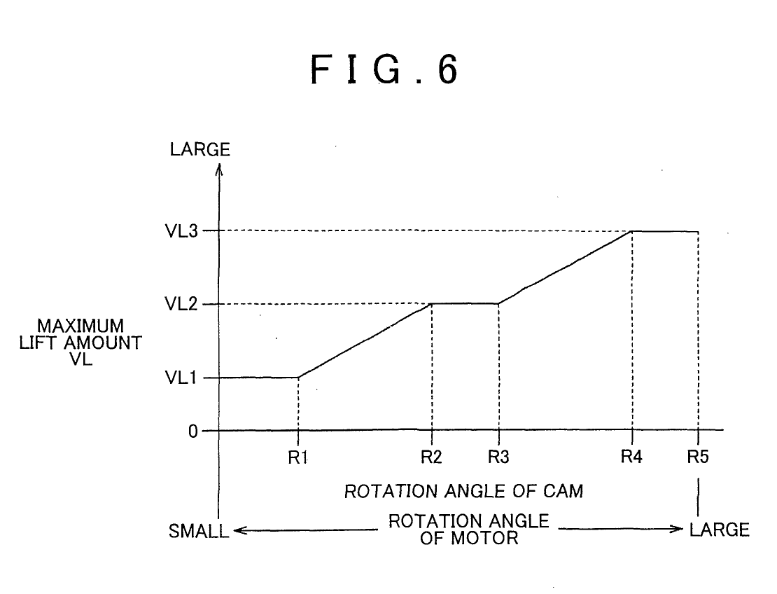

The cam surface of the cam 75 has the cam profile described above, so the maximum lift amount VL of the intake valve 21 changes as shown in FIG. 6 during one rotation of the cam 75. As shown by the horizontal axis in FIG. 6, the rotation angle of the cam 75 increases as the rotation angle of the motor 66 increases. Also, in the zone before the first rotation angle R1 where the roller 76 is in a state contacting the reference circle 75b of the cam 75, the displacement amount of the control shaft 57 is “0”, so the maximum lift amount VL is held at a first lift amount VL1 that is a minimum value. Also, during the process in which the rotation angle of the cam 75 changes from the first rotation angle R1 to the second rotation angle R2, the displacement amount of the control shaft 57 gradually increases, so the maximum lift amount VL gradually increases from the first lift amount VL1.

In the zone from the second rotation angle R2 to the third rotation angle R3, the displacement amount of the control shaft 57 is maintained at “L1” which is constant, so the maximum lift amount VL is held at a second lift amount VL2 that is larger than the first lift amount VL1. Also, during the process in which the rotation angle of the cam 75 changes from the third rotation angle R3 to the fourth rotation angle R4, the displacement amount of the control shaft 57 gradually increases, so the maximum lift amount VL gradually increases from the second lift amount VL2.

In the zone from the fourth rotation angle R4 to the fifth rotation angle R5, the displacement amount of the control she: 57 is maintained at “L2” that is larger than “L1” described above, so the maximum lift amount VL is held at a third lift amount VL3 that is larger than the second lift amount VL2. This third lift amount VL3 is a maximum value of the maximum lift amount VL.

Here, reaction force from the valve spring 23 acts on the output portions 51 of the variable mechanism portion 44, so a force is applied that attempts to reduce the relative phase difference (i.e., the angle θ in FIG. 2) between the input arm 46 and the output arm 52. Therefore, axial force in a direction in which the maximum lift amount VL of the intake valve 21 decreases (i.e., in the direction of the arrow Lo in FIGS. 3 and 4) acts on the slider gear 61 and the control shaft 57. When this axial force is applied to the earn surface of the cam 75 in a zone that changes the displacement amount of the control shaft 57, component force from this axial force is generated. This component force causes rotary torque that acts in the direction in which the maximum lift amount VL decreases to work in the cam 75. Therefore, when an attempt is made to hold the maximum lift amount VL in a zone where the displacement amount of the control shaft 57 changes, force against the rotary torque must be generated by the motor 66, so a holding current needs to be supplied to the motor 66.

On the other hand, when the axial force acts on the cam surface in the holding region of the cam 75, i.e., when the axial force acts on the cam surface in a zone in which the displacement amount of the control shaft 57 is constant due to the cam radius being constant, even if this axial force is applied, component force from this axial force is inhibited from being generated. Therefore, the rotary torque caused by the axial force is inhibited from being generated. Accordingly, when the maximum lift amount VL is held in a zone in which the displacement amount of the control shaft 57 is constant, the holding current supplied to the motor 66 is able to be reduced.

Therefore, in the variable valve mechanism A, any one of the first lift amount VL1, the second lift amount VL2, and the third lift amount VL3 described above is set as the maximum lift amount VL of the intake valve 21, according to the engine operating state. Also, the maximum lift amount VL of the intake valve 21 is changed in three stages by holding the selected lift amount. In this way, the variable valve mechanism A is a multi-stage variable valve mechanism that changes the maximum lift amount is multiple stages.

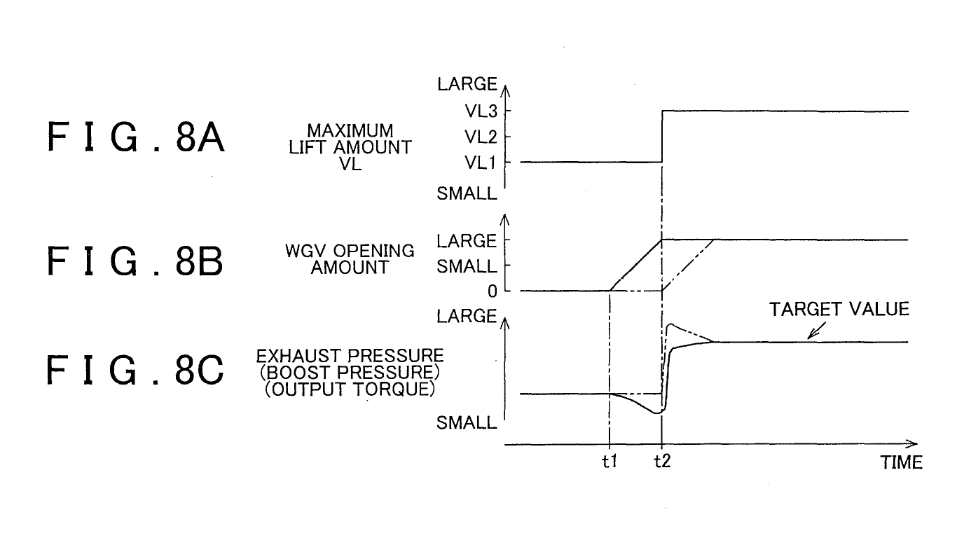

As described above, with the multi-stage variable valve mechanism A in which a plurality of maximum lift amounts VL (VL1, VL2, and VL3) that differ greatly in magnitude from each other are set, the phenomenon described below may occur if the maximum lift amount VL of the intake valve 21 abruptly changes greatly to the increase side, at timing t2 in FIG. 8A.

That is, with the change described above in the maximum lift, amount of the intake valve 21, the amount of air drawn into the combustion chamber 17 abruptly increases, so the output torque of the internal combustion engine 10 may increase all at once. The alternate long and two short dashes line in FIG. 8C indicates the manner of change in the boost pressure (output torque) when the opening amount of the WGV 35 is changed to the increase side at timing t2 as shown by the alternate long and two short dashes line in FIG. 8B. In this way, at timing t2, the boost pressure (output torque) abruptly increases and becomes much larger than the target boost pressure (target output torque). However, the exhaust pressure will decrease by operating the WGV 35 to the open side, so the boost pressure (output torque) is reduced and converges on the target value after abruptly increasing as described above.

Therefore, when there is a request to increase the maximum lift amount VL of the intake valve 21, the engine control unit 82 controls (i.e., drives) the WGV 35 and the variable valve mechanism A as described below, to suppress an abrupt increase in the boost pressure (output torque).

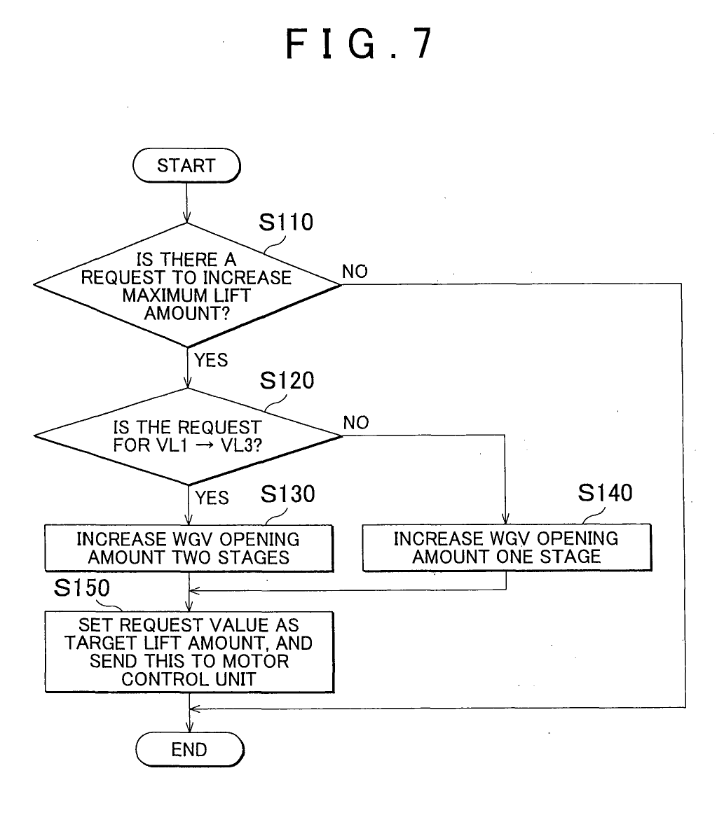

Next, a routine executed by the engine control unit 82 when there is a request to increase the maximum lift amount of the intake valve 21 will be described with reference to the flowchart in FIG. 7, as the operation of this example embodiment. This routine is executed in predetermined cycles.

When this routine starts, first in step S110, it is determined whether there is a request to increase the maximum lift amount VL of the intake valve 21. This request may be a request to change the maximum lift amount VL from the first lift amount VL1 to the second lift amount VL2, a request to change the maximum lift amount VL from the second lift amount VL2 to the third lift amount VL3, or a request to change the maximum lift amount VL from the first lift amount VL1 straight to the third lift amount VL3.

If a determination condition for step S110 is not satisfied (i.e., if none of the requests described above are made), this cycle of the routine ends. On the other hand, if the determination condition for step S110 is satisfied (i.e., if there is a request), the process proceeds on to step S120 where the content of the request is determined. Here, it is determined whether there is a request to change the maximum lift amount VL from the first lift amount VL1 to the third lift amount VL3. This routine is executed to determine whether there is a request to abruptly change the operation angle and the maximum lift amount of the intake valve 21 to a large value on the increase side (i.e. the side on which the operation angle and the maximum lift amount of the intake valve 21 increase).

If the determination condition in step S120 is satisfied, the target opening amount of the WGV 35 is increased two stages in step S130. For example, if the target opening amount of the WGV 35 before the request is “0”, the target opening amount is changed to “Large”. The increase amount in the target opening amount at this time is the maximum in the usable range. Also, the actuator of the WGV 35 is driven (i.e., controlled) such that the actual opening amount comes to match the target opening amount after this change. As a result, the actual opening amount of the WGV 35 increases two stages (from “0” to “Large”).

On the other hand, if the determination condition in step S120 is not satisfied, i.e., if the request is a request to change the maximum lift amount VL from the first lift amount VL1 to the second lift amount VL2, or a request to change the maximum lift amount VL from the second lift amount VL2 to the third lift amount VL3, the process proceeds on to step S140. In step S140, the target opening amount of the WGV 35 is increased one stage. For example, if the target opening amount of the WGV 35 before the request is “0”, the target opening amount is changed to “Small”. Also, if the target opening amount of the WGV 35 is “Small”, the target opening amount is changed to “Large”. In either case, the increase amount of the target opening amount is less than the increase amount in step S130. Also, the actuator of the WGV 35 is driven (i.e., controlled) such that the actual opening amount comes to match the target opening amount after this change. As a result, the actual opening amount of the WGV 35 is increased one stage.

Then after step S130 or step S140, the process proceeds on to step S150. In step S150, a request value for the maximum lift amount VL in step S120 (i.e., the third lift amount VL3 when step S130 was performed, and the second lift amount VL2 or the third lift amount VL3 when step S140 was performed) is set as the target lift amount, and this is sent to the motor control unit 81.

After step S150 is performed, this cycle of the routine ends. In the motor control unit 81 that has received the target lift amount, the rotation phase of the cam 75 corresponding to this target lift amount is calculated, and the rotation angle of the motor 66 is controlled to realize this rotation phase, as described above.

The rotation of the motor 66 is transmitted to the cam 75 via the reduction mechanism 68 and the conversion mechanism 71. The rotation of the cam 75 causes the holder 72 to move along the guide 74, such that the control shaft 57 moves in the axial direction (i.e., the direction of the arrow Hi) with the slider gear 61. The movement of the slider gear 61 causes the relative phase difference (i.e., the angle θ in FIG. 2) between the input arm 46 of the input portion 45 and the output arm 52 of the output portions 51 to increase, so the maximum lift amount VL of the intake valve 21 increases, and consequently, the intake air amount increases.

When the routine in FIG. 7 is performed, and there is a request to change the maximum lift amount VL of the intake valve 21 from the first lift amount VL1 to the third lift amount VL3 according to a change in the engine operating state (i.e., YES in step S120), a process (step S130) is performed to open the WGV 35 to an opening amount two stages on the open side from before the request, at timing t1, as shown by the solid line in FIG. 8B. The amount of exhaust that bypasses the turbine wheel 31 and is discharged via the bypass passage 34 becomes greater than it was before the request. Compared with before the request, the exhaust pressure decreases and the rotation speed of the turbine wheel 31 decreases. With this, the force with which air is fed in by the compressor wheel 33 weakens, so the boost pressure temporarily decreases after timing t1, as shown by the solid line in FIG. 8C.

Also, at timing t2 after the opening amount of the WGV 35 has been increased two stages, the maximum lift amount VL of the intake valve 21 is changed from the first lift amount VL1 to the third lift amount VL3 by the variable valve mechanism A, as shown by the solid line in FIG. 8A.

Therefore, when the maximum lift amount VL of the intake valve 21 is abruptly changed to the increase side, the amount of air drawn into the internal combustion engine 10 abruptly increases, but this increase is performed under a situation in which the boost pressure is reduced as described above, so an abrupt increase in output torque of the internal combustion engine 10 is inhibited, as shown by the solid line in FIG. 8C.

Here, when the maximum lift amount VL of the intake valve 21 is suddenly changed to the increase side by the variable valve mechanism A, the amount of air drawn into the internal combustion engine 10 increases according to the amount of change in the maximum lift amount VL. More specifically, the intake air amount is small when the amount of change in the maximum lift amount VL to the increase side is small, and increases as the amount of change increases.

On the other hand, when the WGV 35 is open, the exhaust pressure and the boost pressure decrease according to the amount of change in the opening amount of the WGV 35 to the open side. More specifically, the exhaust pressure (boost pressure) is small when the amount of change in the opening amount of the WGV 35 to the open side is small, and increases as the amount of change increases.

Regarding this, in this example embodiment, the WGV 35 opens an opening amount according to the requested amount of change in the maximum lift amount VL. More specifically, when the requested amount of change in the maximum lift amount VL is large (i.e., YES in step S120), the WGV 35 opens a large amount. (S130). When the requested amount of change in the maximum lift amount VL is small (i.e., NO in step S120), the WGV 35 opens a small amount (S140).

Therefore, as opposed to when the WGV 35 is always open a constant amount, an abrupt increase in the output torque of the internal combustion engine. 10 caused by a sudden increase in the intake air amount is able to be appropriately suppressed, regardless of the maximum lift amount VL, so the output torque will approach the target value.

Further, with the multi-stage variable valve mechanism A, the first lift amount VL1, the second lift amount VL2, and the third lift amount VL3 are set as the plurality of maximum lift amounts VL that differ greatly in magnitude from each other. Therefore, the amount of change when the maximum lift amount VL changes tends to be more than it is with a continuously variable valve mechanism A that continuously (i.e., smoothly) changes the maximum lift amount VL of the intake valve 21. With the multi-stage variable valve mechanism A, the maximum lift amount VL of the intake valve 21 is more easily abruptly changed greatly to the increase side than it is with a continuously variable valve mechanism A.

Therefore, as described above, in the internal combustion engine 10 provided with the multi-stage variable valve mechanism A, an abrupt increase in the output torque of the internal combustion engine 10 is able to be effectively suppressed by performing the driving control of the WGV 35 and the variable valve mechanism A described above.

Also, with the internal combustion engine 10 provided with the multi-stage variable valve mechanism A, the amount of intake air drawn into the combustion chamber 17 is greater when the maximum lift amount VL is changed to a maximum lift amount VL that is two stages larger, compared to when the maximum lift amount VL is changed to a maximum lift amount VL that is one stage larger. The phenomenon in which the output torque of the internal combustion engine 10 increases all at once following a change in the maximum lift amount VL of the intake valve 21 also tends to occur more easily.

Therefore, with this example embodiment, when there is a request to change from the maximum lift amount VL before the request to a maximum lift amount VL that is two stages larger, from among the plurality of maximum lift amounts VL (i.e., YES in step S120), an abrupt increase in the output torque of the internal combustion engine 10 is able to be effectively suppressed by performing the driving control of the WGV 35 and the variable valve mechanism A (S130 and S150) described above.

One situation in which there is a request to change from the maximum lift amount VL before the request to a maximum lift amount VL that is two stages larger, from among the plurality of maximum lift amounts VL, is when there is a request to change from the first lift amount VL1 that is the smallest maximum lift amount VL to the third lift amount VL3 that is the largest maximum lift amount VL (i.e., YES in step S120). In this case, the maximum lift amount VL will be changed the largest amount of any possible change. The phenomenon in which the output torque of the internal combustion engine 10 increases all at once following a change in the maximum lift amount VL of the intake valve 21 also tends to occur more easily.

Therefore, as described above, when there is a request to change from the first lift amount VL1 that is the smallest to the third lift amount VL3 that is the largest, from among the plurality of maximum lift amounts (VL1, VL2, and VL3), an abrupt increase in the output torque of the internal combustion engine 10 is able to be effectively suppressed by performing the driving control of the WGV 35 and the variable valve mechanism A (S130 and S150) described above.

According -to this example embodiment described in detail above, the effects described below are able to be obtained. When there is a request to increase the maximum lift amount VL of the intake valve 21, the maximum lift amount VL is changed to the increase side by the variable valve mechanism A after the WGV 35 is opened to an opening amount farther on the open side than before the request.

Therefore, when the maximum lift amount VL of the intake valve 21 is abruptly changed to the increase side, the amount of air drawn into the internal combustion engine 10 will abruptly increase, but this increase is able to be performed under a situation in which the boost pressure is decreased, so an abrupt increase in the output torque of the internal combustion engine 10 is able to be suppressed.

When the amount of change in the maximum lift amount VL is large, the WGV 35 opens a larger amount than when the amount of change is small, i.e., the WGV 35 opens an amount according to the requested amount of change in the maximum lift amount VL.

Therefore, an abrupt increase in the output torque of the internal combustion engine 10 due to a sudden increase in the intake air amount is suppressed, so an effect in which the output torque is brought close to the target value is able to be obtained regardless of the amount of change in the maximum lift amount VL.

A multi-stage variable valve mechanism that changes the maximum lift amount VL in multiple stages by selecting from among a plurality of predetermined maximum lift amounts (VL1 to VL3) is used as the variable valve mechanism A.

Therefore, in the internal combustion engine 10 provided with the multi-stage variable valve mechanism A, an effect in which an abrupt increase in the output torque of the internal combustion engine 10 is suppressed is able to be effectively obtained by performing the driving control of the WGV 35 and the variable valve mechanism A described above.

A request to change from a maximum lift amount VL before the request, to a maximum lift amount VL two stages larger, from among the plurality of maximum lift amounts VL, is included as a request to increase the maximum lift amount VL of the intake valve 21. In this example embodiment, the three maximum lift amounts VL (VL1, VL2, and VL3) are set, and a request to increase from the first lift amount VL1 that is the smallest to the third lift amount VL3 that is the largest, from among these, is included as a request to increase the maximum lift amount VL of the intake valve 21.

Therefore, an abrupt increase in the output torque of the internal combustion engine 10 is able to be suppressed, so the effect described above is able to be effectively obtained, compared to when the request to increase the maximum lift amount VL of the intake valve 21 only includes a request to change the valve characteristic from a maximum lift amount VL before the request to a maximum lift amount VL one stage larger.

The example embodiment may also be carried out as a modified example in which it is changed as described below. The maximum lift amount VL of the intake valve 21 that is changed by the variable valve mechanism A may also be set to two or four or more.

In the example embodiment described above, the number of maximum lift amounts VL can be changed by changing i) the number of zones in which the displacement amount of the control shaft 57 increases linearly by gradually increasing the cam radius in one direction, and ii) the number of zones in which the displacement amount of the control shaft 57 is constant by the cam radius being constant, on the cam surface of the cam 75.

When two maximum lift amounts VL are set, a request to increase the maximum lift amount VL is a request to increase the maximum lift amount VL from the lift amount before the request to a lift amount that is one stage larger. Also, when the maximum lift amount VL is set to “4” or more, a request to increase the maximum lift amount VL may include a request to increase the maximum lift amount VL from the maximum lift amount VL before the request to a maximum lift amount VL two or more stages larger. As a result, effects similar to those above can be obtained.

The variable valve mechanism A may also change the valve characteristic in stages by a structure different than that described in the example embodiment above. For example, with a valve mechanism that includes a direct-acting valve system, the variable valve mechanism A may change the operation amount of a valve lifter that operates by the cam in multiple stages. Also, with a valve mechanism that includes a rocker arm valve system, the variable valve mechanism A may change a sinking amount of a lash adjuster that supports the rocker arm in multiple stages, or may change the shape of the rocker arm in multiple stages.

The variable valve mechanism A may also change only one of the operation amount (valve open period) and the maximum lift amount of the intake valve 21. The variable valve mechanism A may also be provided with a valve mechanism for the exhaust valve 22, in addition to the valve mechanism for the intake valve 21.

When there is a request to increase the maximum lift amount, the target opening of the WGV 35 may be set from among two types or four or more types of values.

In the flowchart in FIG. 7, when there is a request to change from the maximum lift amount VL before the request to a maximum lift amount VL one stage larger, from among the plurality of maximum lift amounts VL (VL1 to VL3) (i.e., NO in step S120), the maximum lift amount may not be changed to the request value by not changing the opening amount of the WGV 35.

The control apparatus of the internal combustion engine is not limited to a multi-stage variable valve mechanism, but may be applied also to an internal combustion engine provided with a continuously variable valve mechanism that changes the valve characteristic of the intake valve continuously (i.e., smoothly). This is because even with a continuously variable valve mechanism, there are cases in which the valve characteristic abruptly changes greatly to the increase side.

1. An internal combustion engine comprising:
a variable valve mechanism configured to take at least one of an operation angle or a maximum lift amount of an intake valve as a valve characteristic, and changes the valve characteristic according to an engine operating state;
a turbocharger that includes a bypass passage that bypasses a turbine wheel arranged in an exhaust passage by connecting a portion of the exhaust passage that is upstream of the turbine wheel to a portion of the exhaust passage that is downstream of the turbine wheel, and a waste gate valve configured to adjust a flow path area of the bypass passage; and
a control apparatus configured to, when there is a request to increase the valve characteristic according to a change in the engine operating state, change the valve characteristic to an increase side with the variable valve mechanism after opening the waste gate valve to an opening amount that is larger than an opening amount before the request.

2. The internal combustion engine according to claim 1, wherein
the control apparatus is configured to open the waste gate valve to an opening amount according to a requested amount of change in the valve characteristic.

3. The internal combustion engine according to claim 2, wherein
the control apparatus is configured to open the waste gate valve to a larger amount when the requested amount of change in the valve characteristic is large than when the requested amount of change in the valve characteristic is small.

4. The internal combustion engine according to claim 1, wherein the variable valve mechanism is a multi-stage variable valve mechanism configured to change the valve characteristic in multiple stages by selecting one from among a plurality of predetermined valve characteristics.

5. The internal combustion engine according to claim 4, wherein three or more of stages of the valve characteristics are set, and the request includes a request to change the valve characteristics from a valve characteristic before the request to a valve characteristic two stages larger, from among the plurality of valve characteristics.

6. The internal combustion engine according to claim 5, wherein the request includes a request to change the valve characteristics from a smallest valve characteristic to a largest valve characteristic, from among the plurality of valve characteristics.

7. A control method for an internal combustion engine, the internal combustion engine including a variable valve mechanism configured to take at least one of an operation angle or a maximum lift amount of an intake valve as a valve characteristic, and changes the valve characteristic according to an engine operating state; and a turbocharger that includes a bypass passage that bypasses a turbine wheel arranged in an exhaust passage by connecting a portion of the exhaust passage that is upstream of the turbine wheel to a portion of the exhaust passage that is downstream of the turbine wheel, and a waste gate valve configured to adjust a flow path area of the bypass passage, the control method comprising:
when there is a request to increase the valve characteristic according to a change in the engine operating state, changing, by a control apparatus, the valve characteristic to an increase side with the variable valve mechanism after opening the waste gate valve to an opening amount that is larger than and opening amount before the request.
